(19) United States
(12) Patent Application Publication
(10) Pub. No.: US 2008/0308737 A1
(43) Pub. Date: Dec. 18, 2008

(54) Optical Stabilization of a Detector

(76) Inventors: Jurgen Stein, Wuppertal (DE); Guntram Pausch, Dresden (DE)

Correspondence Address: IP STRATEGIES, 12 1/2 WALL STREET, SUITE E, ASHEVILLE, NC, 28801, US

(21) Appl. No.: 11/572,941

(22) PCT Filed: Aug. 2, 2004
(86) PCT No.: PCT/EP2004/008643

§ 371 Date: Dec. 14, 2007

(51) Int. Cl. G01T 1/202

(52) U.S. Cl. 250/370.11

(57) ABSTRACT

The invention relates to a detector comprising a scintillator, preferably a scintillator crystal, a light detector with at least one photocathode and a photoelectrometer, preferably a photomultiplier or a hybrid photomultiplier, and a light source, preferably an LED, a laser or a laser diode. The inventive detector is characterized in that it is configured in such a manner that the light produced in the scintillator and the light produced in the light source are injected into the light detector in different sites.

The invention relates to a detector comprising a light source according to the preamble of claim 1.

In prior art, detectors are known, in particular scintillation detectors, which detect events, which are particularly triggered by ionizing radiation, and emit light as a result of the detection. This light is converted into electrical charge in a light detector, mostly by means of a photo cathode. The measured charge, thereby, regularly is too low such that it has to be further amplified to allow the subsequent evaluation and signal processing. Thereby, the further amplification regularly results by means of photo multipliers.

Usually a crystal, for example NaI(Tl), CsI or BGO is used as scintillator. Also, scintillators made from plastic or liquid scintillators are used.

The scintillator optically is connected to a light detector, mostly a photo multiplier with photo cathode, whereby regularly the photo cathode is positioned on the inside of the entrance window of the photo multiplier. The connection between the scintillator and the entrance window of a photo multiplier/light detector mostly is effected directly in that the photo multiplier is connected to the scintillator. However, other solutions are known, according to which a connection is realized by means of a light conductor or according to which the scintillator and light detector are connected to each other mechanically such that the connection merely is optical.

The outer wall of the photo multiplier including the entrance window with the photo cathode applied to the rear side regularly comprises glass as material. However, also other materials are conceivable which are transparent for light.

The electrons produced at the front end of the photo multiplier in the photo cathode are accelerated over a dynode path which is mounted in the inside of the photo multiplier and are multiplied such that at the end of the dynode path regularly an electrical pulse can be measured which is suitable for further signal processing and evaluation. The electrical connections for the voltage supply of the dynode chain as well as the signal outputs mostly can be found at or adjacent to the rearward part of the photo multiplier opposite to the entrance window. The amplitude of the eventually measured current pulse approximately is proportional to the amount of detected light, and thereby, mostly also approximately to the energy of the radiation absorbed in the scintillator.

It is known that detectors have to be calibrated and stabilized, because the light efficiency in the scintillator and also the amplification of the photo multiplier depend on external factors, particularly also on the operating temperature and the counting rate. Mostly a combined calibration and stabilization of the entire detector comprising a scintillator, light detector, amplifier and housing is carried out in that a radio active calibration source is employed the radiation of which is detected by the scintillator and is analyzed by the light detector.

Due to several grounds, however, often it is not possible or not desirable to also use a calibration source of sufficient strength for the to a large extent continuous stabilization which is required for the parallel calibration. Therefore, frequently after a single calibration of the entire detector, the light detector is stabilized separately. By this to a large extent continuous stabilization of the light detector the calibration is largely maintained. Additionally, light sources are employed, which can emit a defined amount of radiation, as for example LEDs.

The light of these light sources, thereby, is coupled into the optical measurement path, thus, into the path of the light, which during radiation measurement enters into the light detector from the scintillator (measurement light path). The coupling, thereby, mostly it is effected via a light conductor directly into the scintillator. It is also known to couple the light of the light source into the optical path between scintillator and light detector as far as this connection is realized over a light conductor. Thereby, the light emitted from the light source reaches the photo cathode via the entrance window of the photo multiplier, where it is converted into an electrical signal.

A disadvantage of the known system is the essential complexity of the assembly, because the light of the light source has to be coupled into the measurement light path without interfering with the latter. Thus, it is known that interfaces, for example the transition from the light conductor or the light source directly to the scintillator, modify the structure of the scintillator, and thereby interfere which leads to a degradation of the measurement accuracy. Moreover, such interfaces are strongly temperature sensitive. To keep the remaining interference as small as possible, high demands have to be made on the constitution and design of these interfaces.

This complexity of the assembly leads to a replacement of the light source not being possible or only with substantial technical effort. At the same time, this leads to substantial costs of the entire system.

A further disadvantage which is important for practice is that a back fitting of already present detectors which not yet have such a light source for calibration purposes, is not possible, at least not in a technically and economically reasonable manner, because the already existing detector would have to be completely disassembled for mounting such a light source.

Therefore, it is an object of the present invention to avoid the disadvantages of prior art described above, and to provide a system which is constructed technically simple and robust, enables a simple replacement of the light source, and allows for back fitting of existing detector systems with light sources for calibration purposes.

This object is solved according to the invention by a detector having a scintillator, preferably a scintillator crystal, a light detector having at least a photo cathode and a photo electron measurement apparatus, preferably a photo electron multiplier (photo multiplier) or a combination of an electron accelerator and a particle detector (hybrid photo multiplier) and further a light source, preferably an LED, a laser or a laser diode. The detector, thereby, is constructed such that the light generated in the scintillator and the light generated in the light source are coupled into the light detector at different locations. Thereby, the path of the light emitted from the light source and coupled into the photo cathode differs from the measurement light path.

According to a preferred embodiment, the light detector is constructed such that the light emitted from the light source predominantly enters into the photo cathode via the inside of the photo electron measurement apparatus. Preferably, the photo electron measurement apparatus has a transparent body, especially preferably made from glass. The light emitted from the light source enters into the photo cathode according to a very preferred embodiment at least partially over the exterior substantially transparent wall of the light detector.

The light source preferably has an LED, the light of the light source is then preferably coupled into the interior of the detector directly or via a light conductor. It is especially preferred that the light source is arranged around the rear region, preferably behind the photo electron measurement apparatus such that the light emitted from the light source is substantially coupled into the light detector via the rear part of the transparent wall of the light detector.

According lo a preferred embodiment of the detector according to the present invention the light of the light source is coupled into the interior of the detector via a collimator. According to another aspect of the invention, however, the light can also be coupled into the glass body of the light detector directly via a light conductor or via a light source directly attached to the glass body.

Further, it has been found to be advantageous to attach the light source on a conductor board on which at least part of the electronics required for the light source is accommodated. The light source, moreover, can also be attached outside the detector housing, whereby the light of the light source then is coupled into the interior of the detector via an optical connection, preferably a window, especially preferably a light conductor.

Several specific embodiments are explained by means of the following figures in detail. There is shown in

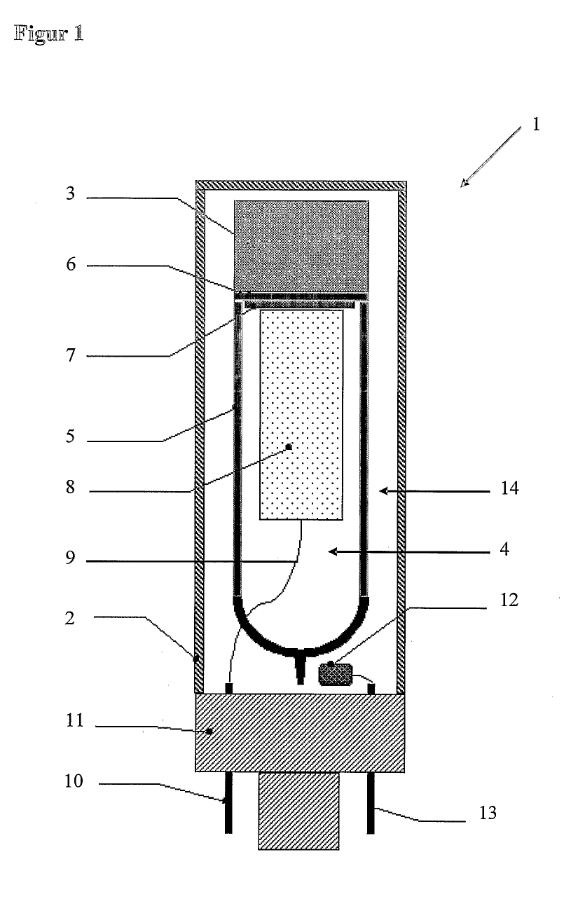

FIG. 1 a detector with a light source attached within the detector interior;

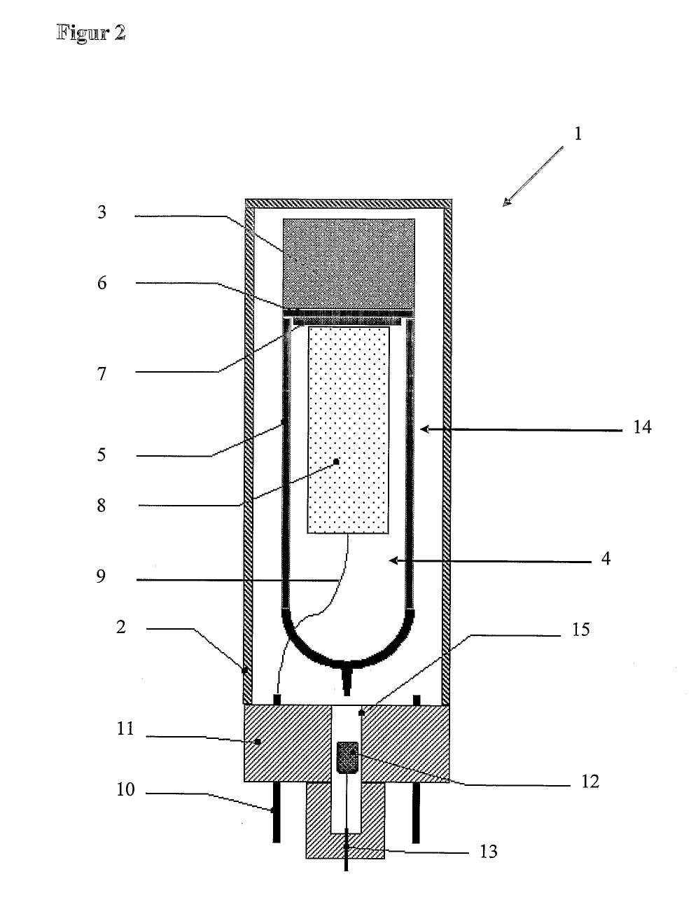

FIG. 2 a detector with a light source in the detector interior including a collimator;

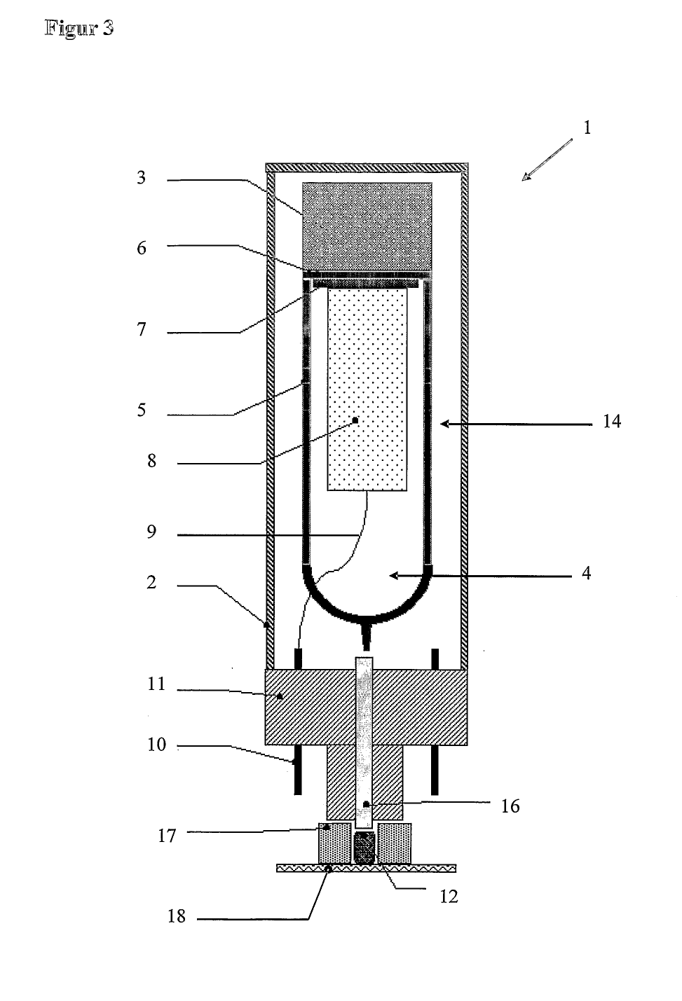

FIG. 3 a detector according to which the light of an external light source is coupled into the interior of the detector via a light conductor;

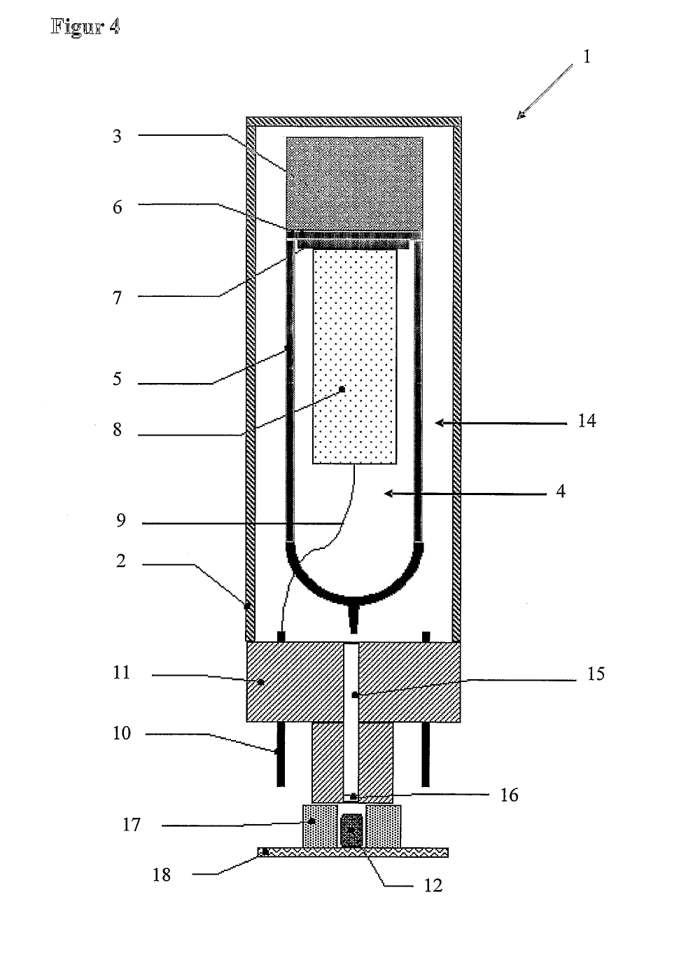

FIG. 4 a detector with an externally attached light source the light of which is directed via an optical window and a collimator into the detector interior;

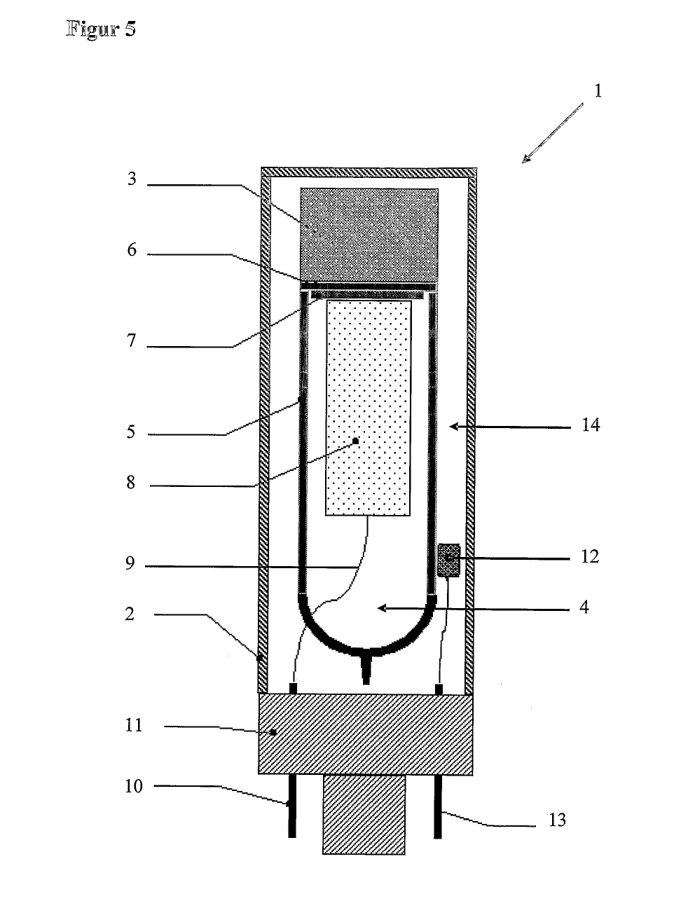

FIG. 5 a detector according to which the light source is attached immediately at the photo multiplier;

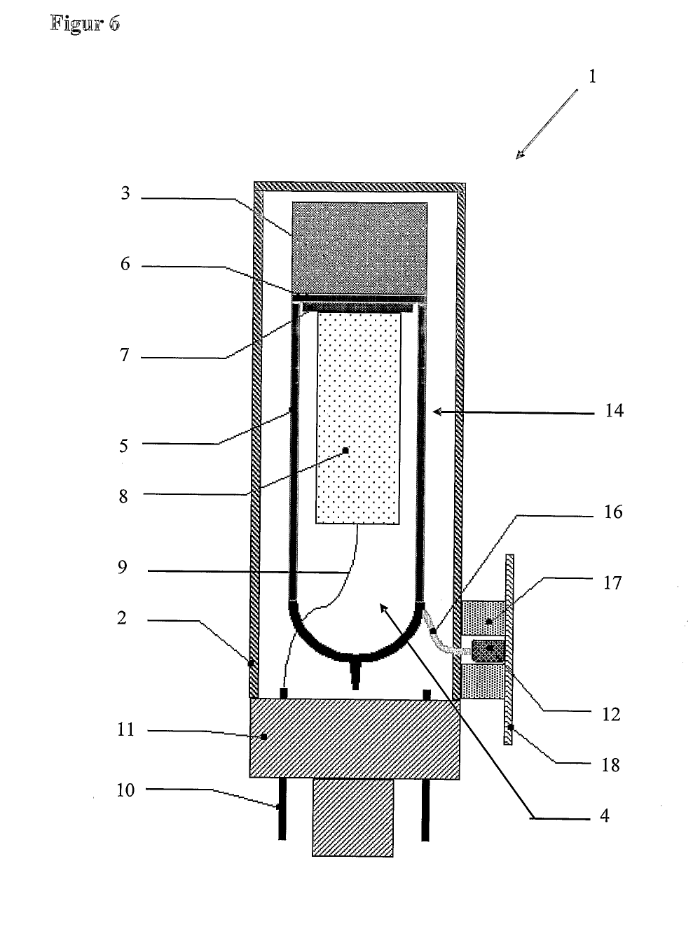

FIG. 6 a detector with a light source which is connected immediately via a light conductor to the photo multiplier; and

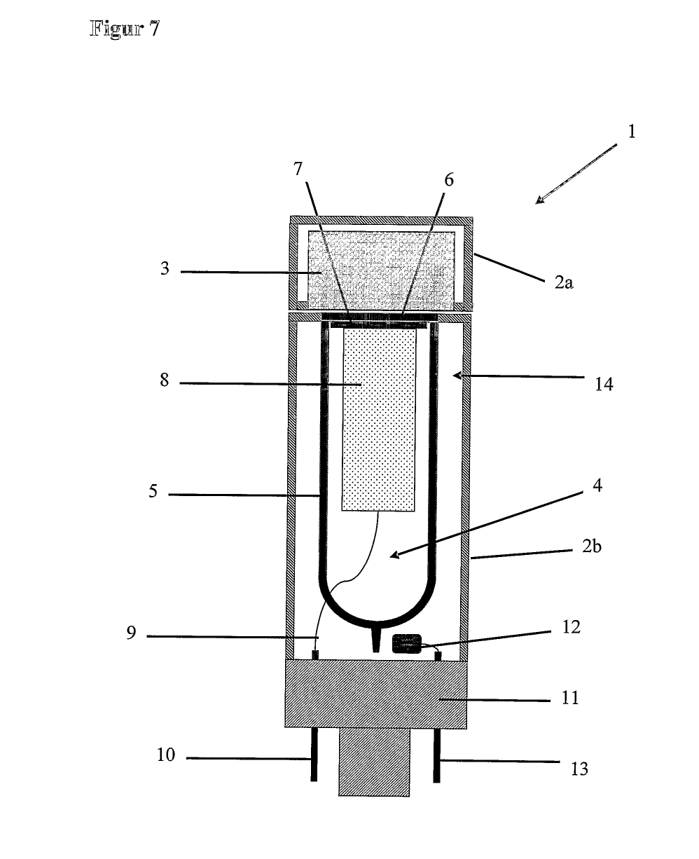

FIG. 7 a two-part detector, according to which the scintillator and the light detector are separate.

FIG. 1 shows a detector 1 with a detector housing 2. The detector housing is light-proof such that the part of the detector which is inside the housing is not negatively influenced by external influences of scattered light.

In the interior of the detector there is a scintillator crystal 3 which absorbs the radiation to be measured. To loose as little light generated in the scintillator as possible, the scintillator crystal 3 on its exterior is provided with a substantially to a large extent diffusely reflecting layer such that the light generated in the scintillator can leave the crystal 3 substantially only on one side.

This translucent side of the crystal 3 optically is in contact with the light detector which substantially comprises the photo multiplier 4 with the photo cathode 7. In particular, the translucent side of the crystal 3 is in optical contact with the light entrance window 6 of the photo multiplier 4 belonging to the glass body 5. In the illustrated embodiment the scintillator crystal is planar at the light output region as well as the light entrance window 6 of the photo multiplier 4. This, however, does not always have to be the case. Moreover, also an indirect coupling of the scintillator to the photo multiplier, for example, by means of a light conductor, is conceivable. It only has to be guaranteed that during radiation measurement sufficient light reaches into the light entrance window 6 of the photo multiplier 4 from scintillator 3.

At the inner side of the light entrance window 6 of the photo multiplier 4 there is the photo cathode 7. Behind the photo cathode 7, the dynode path 8 is arranged, which is known in prior art, and, therefore, is not shown in detail. The power supply of the dynodes 8 is effected by voltage supplies 9, which are connected to a plug 10 of the detector base 11. In the interior 14 of the detector, there is a light source 12, which here is formed as an LED. The power supply of the LED is effected over an electrical plug 13 which is also embedded in the base 11.

The light of the light source 12 is radiated during calibration into the interior 14 of the detector in a diffuse manner and, therefore, cannot reach into the photo cathode 7 over the scintillator crystal 3 which is shielded in a light-proof manner against the interior 14. In fact, it is also conceivable to remove a part of the light-proof reflective coating of the scintillator crystal 3 such that the light also can reach into the photo cathode 7 at least via the scintillator crystal 3, however, the light efficiency of the scintillator 3 can thereby be degraded, which should be avoided in most cases.

In the illustrated embodiment the light emitted from the light source 12 enters into the glass body 5 of the photo multiplier 4 at not further defined positions. The latter partly functions as a sort of light conductor and directs the light at least partially through the photo cathode 7. A part of the light can also pass through the glass body 5 from the light source directly, and is partially reflected and scattered in the interior of the dynode structure, and therefore, can reach the photo cathode 7 directly from the rear side.

The invention is based on the surprising finding that it is not necessary for calibrating the light detector to couple the light into the light detector on the normal light path, but that it is rather absolutely sufficient to direct the light in a diffuse manner on a not further determined light path to the light detector 7. Thereby, it is unnecessary to know which amount of light reaches the light detector, as long as only the path of the light remains unchanged at least during the measurement.

As shown in FIG. 1, the light source can be connected to the base 11 of the detector housing 2 such that the light source can easily be separated with the base 11 from the detector 1 and its housing 2. Because the light source otherwise is not connected to the detector, thus, it can be easily replaced. It is also clearly obvious that a back fitting of a light source 12 is possible without any problems in this manner, because also no connection to the remaining detector 1, in particular, not to the detector crystal 3, is required.

FIG. 2 shows a modified embodiment. Here, the light source 12 is accommodated in a recess 15 of the base 11 of the detector housing 2. Due to the light source 12 being displaced in a rearward direction the recess 15 functions as collimator such that the light of the light source 12 reaches the rear side of the glass body 5 of the photo multiplier 4 in a better defined geometrical shape. At the same time, the replaceability of the light source 12 in the base 11 is facilitated.

In a further embodiment, which is shown again in FIG. 3, the light source 12 is attached outside the actual base 11 of the detector housing 2. The light-proof base 17 in which the light source 12 is placed, can thereby also be fixedly connected to the base 11 of the detector housing 2. The light emitted from the light source 12 is directed via a light conductor 16 into the interior 14, whereby the light, as shown, can be directed to the rear side of the glass body 5 of the photo multiplier 4. However, also other positions are conceivable, at which the light conductor 16 terminates in the interior 14 of the detector 1, as long as sufficient light reaches the photo cathode 7.

Thereby, as shown in FIG. 3, the light source can be an LED, which is directly attached to a printed circuit board 18 and is connected via the light-proof base 17 to the light conductor. Thereby, it is possible to integrate the electronics for control and for operation of the LED, which increases the operability and which reduces the technical and financial effort for realization.

FIG. 4 shows a further variant of the embodiment shown in FIG. 3, according to which the light of the light source 12 reaches the interior 14 of the detector 1 via an optical window 16 and a collimator 15.

It is not necessary to couple the light of the light source 12 into the interior 14 of the detector 1 in a diffuse manner, but rather, the light coupling into the glass body 5 of the photo multiplier 4 can also be reflected at a especially suitable discrete position of the glass body 5 which is designated for this purpose. However, the coupling does not result via the light entrance window 6, and thereby substantially not at the spot which is designated for the light coupling for the photo cathode 7. It is, moreover, also further remote from the photo cathode 7 than the spot, at which the light of the scintillator 3 substantially is coupled into the photo multiplier 4.

FIG. 5 shows such an embodiment, according to which the light source 12 is directly attached to the glass body 5 of the photo multiplier 4, for example, adhered thereto, such that the light is coupled in directly.

A further embodiment is shown in FIG. 6, according to which the LED 12 again is directly placed on a printed circuit board 18, which can also comprise the supply and operation electronics of the LED. Via a light-proof base 17 the LED is then connected to the housing 2 of the detector 1, such that no scattered light can reach into the space, in which the LED 12 is positioned. The light of the LED 12 is coupled via a light conductor 16 directly to the glass body 5 of the photo multiplier 4, whereby the light coupled into the glass body 5 then reaches at least partially the photo cathode 7 by scattering and reflection, such that the photo multiplier can be stabilized.

FIG. 7 shows an embodiment according to which the detector 1 is composed of several parts in that a scintillator 3 and a photo multiplier 4 are provided with separate housings 2a and 2b. Here, the light of the light source 12 is radiated into the interior of the housing 2b, which includes the photo multiplier 4, such that it can reach the photo cathode via this interior 14 according to the already described variants.

In this embodiment the scintillator 3 is optically connected to the light entrance window 6 of the otherwise substantially light-proof closed housing 2b, such that the light emitted from the scintillator 3 can be detected in the light detector. For this, the scintillator 3 does not have to be mechanically connected to the light entrance window 6, because an optical connection is sufficient. Such separated detectors are mainly employed, if the scintillator 3 is to be employed in a more flexible manner, because the comparatively large housing 2b can be arranged separately, but also when liquid scintillators are employed.

A separate detector arrangement also is advantageous for a couple of special applications. For example, there are detectors for the under water measurement of radio active radiation which use the water surrounding the scintillator, or, for example, to detect Cherenkow-radiation. Also according to such detectors, the photo multiplier can be stabilized by means of a light source arranged according to the present invention.

Also, further embodiments are conceivable according to which the light of the light source 12 follows a different path according to the present invention than that of the light generated by the radiation events in the scintillator, but which, nevertheless, reaches the photo cathode. Thereby, it is irrelevant whether the light reaches the photo cathode 7 through the light entrance window 6 of the photo multiplier 4 or over another path, even if it is via the rear side of the photo cathode. A calibration of the photo multiplier is possible in all cases such that the exact light path or only the knowledge of the very exact light path is irrelevant.

### LIST OF REFERENCE NUMERALS

1 detector
2 detector housing
3 scintillator
4 photo multiplier
5 glass body
6 light entrance window
7 photo cathode
8 dynode path
9 power supply for the dynodes
10 power plug for the dynodes
11 base of the detector housing
12 light source
13 voltage supply of the light source
14 interior of the detector
15 light well (collimator)
16 light conductor/optical window
17 light-proof base
18 printed circuit board/conductor board

1. Detector (1) comprising a scintillator (3), preferably a scintillator crystal, a light detector with at least one photo cathode (7) and a photo electron measurement apparatus (4), preferably a photo multiplier or a hybrid-photo multiplier, and a light source (12), preferably an LED, a laser or a laser diode, characterized in that the detector (1) is configured such that the light generated in the scintillator (3) and the light generated in the light source (12) are coupled into the light detector at different positions.

2-12. (canceled)
